(19) United States
(12) Patent Application Publication
(10) Pub. No.: US 2011/0078429 A1
(43) Pub. Date: Mar. 31, 2011

(54) ELECTRONIC DEVICE AND BOOTING METHOD THEREFOR

(75) Inventors: PENG-ZHENG YANG, Tu-Cheng (TW); CHIH-YUAN CHUANG, Tu-Cheng (TW)

(73) Assignee: HON HAI PRECISION INDUSTRY CO., LTD., Tu-Cheng (TW)

(21) Appl. No.: 12/624,923

(22) Filed: Nov. 24, 2009

(30) Foreign Application Priority Data
Sep. 30, 2009 (CN) 200910308047.3

(51) Int. Cl. G06F 15/177

(52) U.S. Cl. 713/2

(57) ABSTRACT

An electronic device with a plurality of operating systems includes a mode selecting module, a firmware module, an operating system selecting module and a boot loader module. The mode selecting module selects a desired booting mode from a plurality of booting modes. The booting modes includes a manufacture booting mode, a normal booting mode, a rescue booting mode, and a recover booting mode. The firmware module stores the manufacture booting mode, the normal booting mode, the rescue booting mode, and the recover booting mode. The operating system selecting module selects from a plurality of operating systems according to the selected booting mode. The boot loader module loads the selected operating system. A booting method for the electronic device is also disclosed.

### BACKGROUND

1. Technical Field

The present disclosure relates to an electronic device having multiple operating systems (OSs) and a booting method for the electronic device.

2. Description of Related Art

Nowadays, a user of an electronic device (such as a computer) is free to purchase and install an operating system that differs from the one installed on the device when it was purchased. There are numerous commercially available operating systems to choose from including, but not limited, to MS-DOS, UNIX, LINUX, OS/2, WINDOWS 3.x, WINDOWS NT, and WINDOWS 95.

Although these operating systems perform similar tasks, and many are capable of running the same application programs, each operating system has its own strengths. Sometimes a user wishing to capitalize on the strengths of these operating systems will install more than one OS on the same computer. Commercially available software utilities aid a user in installing additional operating systems on their computers. These utilities also allow a user to choose which operating system to boot while a computer is being powered-on or reset. The capability to boot different operating systems on the same computer is often referred to as an OS multi boot or multi booting. Despite the fact that many attempts have been made in the art, this kind of technology still has much room for improvement.

### BRIEF DESCRIPTION OF THE DRAWINGS

FIG. 1 a schematic block diagram of an electronic device in accordance with one embodiment.

FIG. 2 is a flow chart of a booting method for an electronic device in accordance with one embodiment.

FIGS. 3a and 3b is a flow chart of a booting method for an electronic device in a manufacture booting mode.

FIG. 4 is a flow chart of a booting method for an electronic device in a rescue booting mode.

FIG. 5 is a flow chart of a booting method for an electronic device in a recover booting mode.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

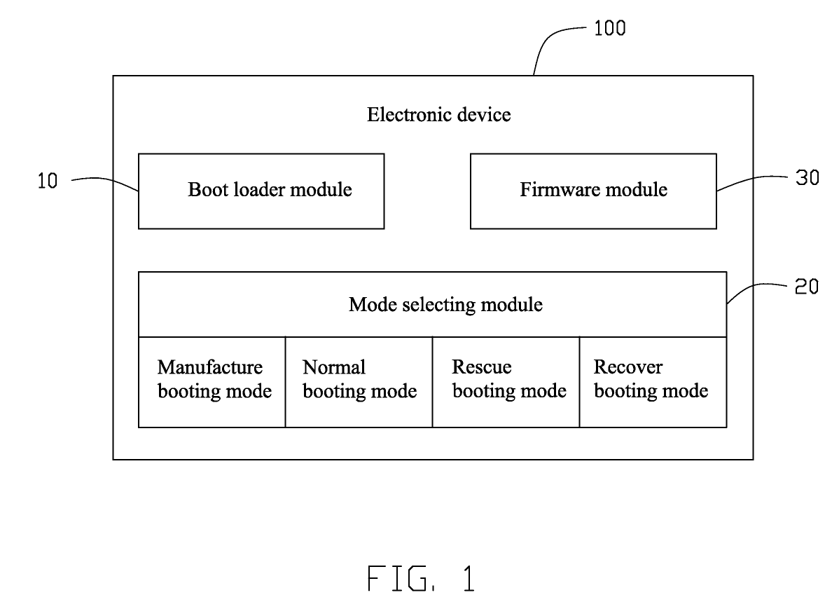

Referring to FIG. 1, an electronic device 100 in accordance with one embodiment includes a boot loader module 10, a mode selecting module 20, and a firmware module 30. The electronic device 100 stores programs and data of different OSs (e.g., WINDOWS 2000, WINDOWS XP, WINDOWS VISTA, LINUX, etc).

A memory space of the electronic device 100 can be divided into several areas. Each of the areas is configured to store the programs and data of the OS. In one embodiment, programs of WINDOWS XP OS are stored in one of the areas; programs of LINUX OS are stored in another one of the areas.

The boot loader module 10 includes a small program that can selectively load the operating system programs at boot.

The mode selecting module 20 is capable of selecting Mode1, Mode2, Mode3, or Mode4. Model is a manufacturing boot applicable while manufacturing the electronic device 100. Mode2 is a normal boot applicable to a common usage of the electronic device 100. Mode3 is a rescue boot mode applicable while repairing the electronic device 100. Mode4 is a recovery boot applicable while restoring the electronic device 100 to factory settings. Mode2 is set as the default boot. If the electronic device 100 does not receive any command to interrupt the boot up process, the default boot is automatically selected. If the electronic device 100 receives a specified command during the booting process, another booting mode other than the default booting mode can be selected according to user's selection.

In one embodiment, the electronic device 100 can be a personal computer or other consumer electronic devices, such as a digital photo frame, a mobile phone, etc. If a common consumer uses the electronic device 100, the mode selecting module 20 can automatically select the normal booting mode applicable to the common user. During manufacturing the electronic device 100, a hotkey can be pressed to control the 100 to bootup the manufacture boot. If the electronic device 100 is being repaired, the mode selecting module 20 can select the rescue booting mode according to user's selection. If the electronic device 100 needs to be restored to factory settings, the mode selecting module 20 can select the recover booting mode according to user's selection.

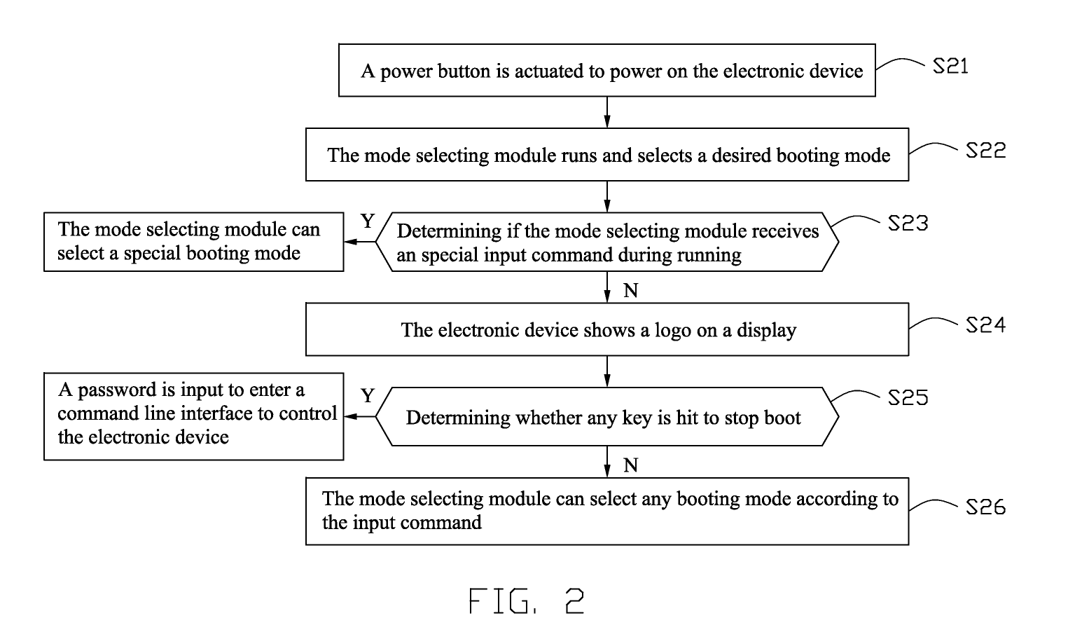

Referring to FIG. 2, one embodiment of a booting method for the electronic device 100 includes following blocks.

In block S21, a power button of the electronic device 100 is actuated to power on the electronic device 100.

In block S22, the mode selecting module 20 runs and selects a desired booting mode. If the mode selecting module 20 does not receive any input command during running, the mode selecting module 20 automatically selects the default booting mode (e.g. normal booting mode). If the mode selecting module 20 receives an input command during running, the mode selecting module 20 can select another booting mode (e.g. the manufacture booting mode, the rescue booting mode, or the recover booting mode) according to the input command.

In block S23, if the mode selecting module 20 receives a special input command during running, the mode selecting module 20 can select a special booting mode.

In block S24, the electronic device 100 shows a logo on a display.

In block S25, determining whether any key is hit to stop booting. If any key is hit, a password is input to enter a command line interface to control the electronic device 100, for example, entering DOS (disk operating system).

In block S26, the mode selecting module 20 can select any booting mode (e.g. the manufacture booting mode, the rescue booting mode, or the recover booting mode) according to the input command.

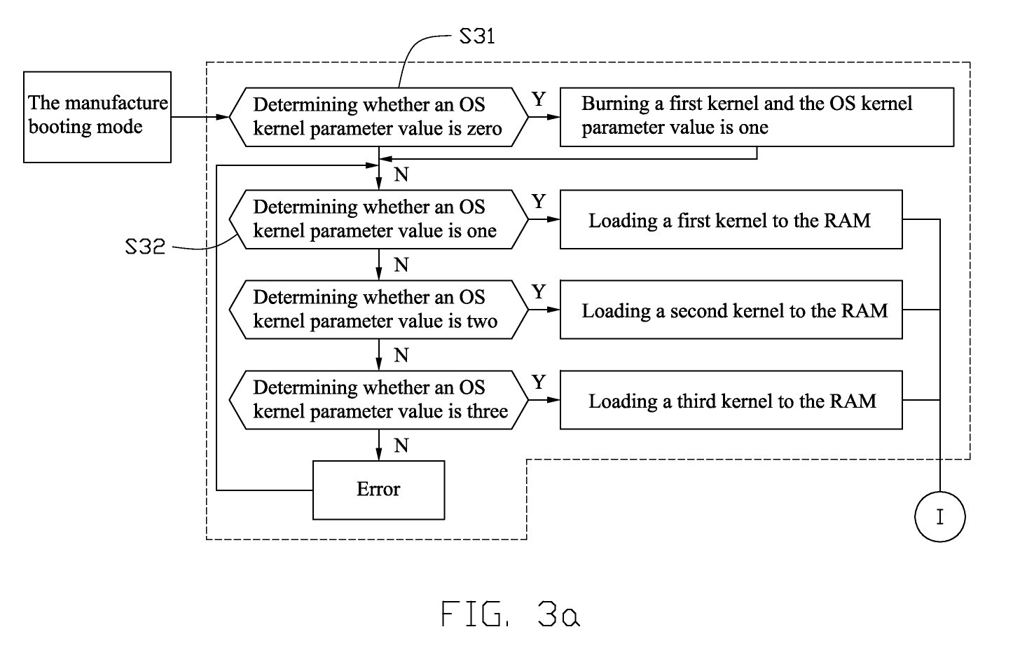

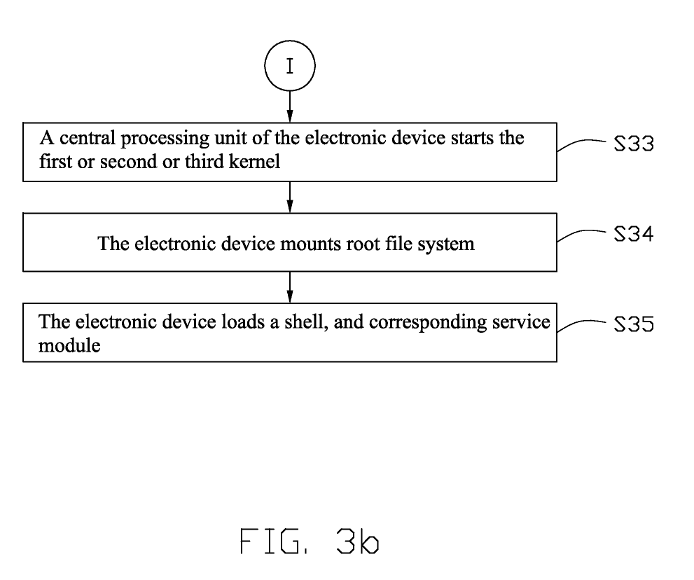

Referring to FIGS. 3a and 3b, one embodiment of a booting method for the electronic device 100 includes following blocks in the manufacture booting mode.

In block S31, determining whether an OS kernel parameter value is zero. If the OS kernel parameter value is zero, burning a first kernel and setting the OS kernel parameter value to one.

In block S32, when the OS kernel parameter value is one, the first kernel is loaded to the RAM. Determining whether the OS kernel parameter value is two, a second kernel is loaded to the RAM if yes. Determining whether the OS kernel parameter value is three, a third kernel is loaded to the RAM if yes. If not, it will be handled as an error.

In block S33, a central processing unit of the electronic device 100 starts one of the first, second and third kernel.

In block S34, the electronic device 100 mounts root file system.

In block S35, the electronic device 100 loads a shell (user interface application system), and corresponding service module. For example, firmware upgrade module.

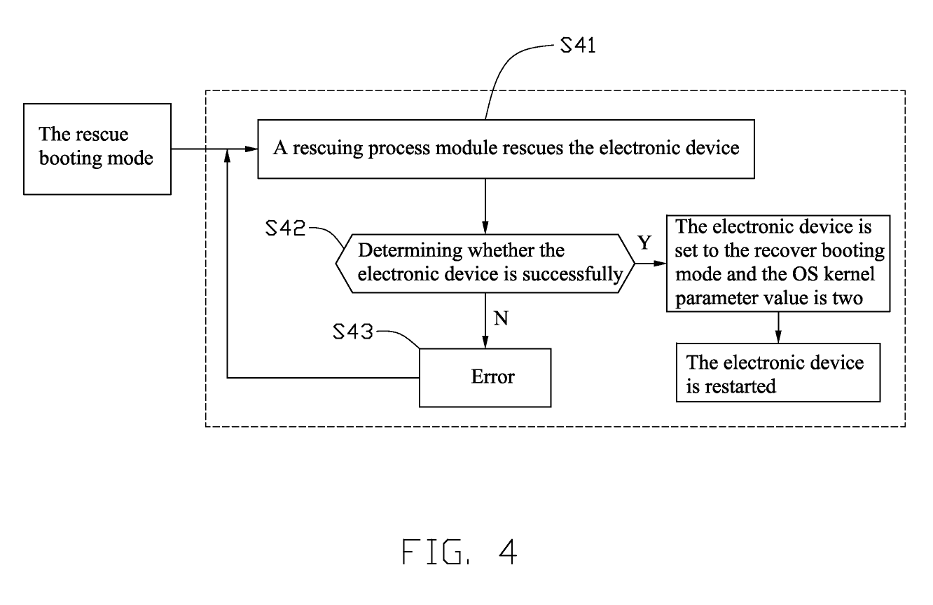

Referring to FIG. 4, one embodiment of a booting method for the electronic device 100 includes following blocks in the rescue booting mode.

In block S41, a rescuing process module rescues the electronic device 100.

In block S42, determining whether the electronic device 100 is successfully rescued. If the electronic device 100 is successfully rescued, the electronic device 100 is set to the recover booting mode and the OS kernel parameter value is two. When the OS kernel parameter value is two, the OS kernel is a new firmware. When the OS kernel parameter value is one, the OS kernel is an initial firmware. The electronic device 100 is restarted.

In block S43, if the electronic device 100 is not successfully rescued, it is handled in error.

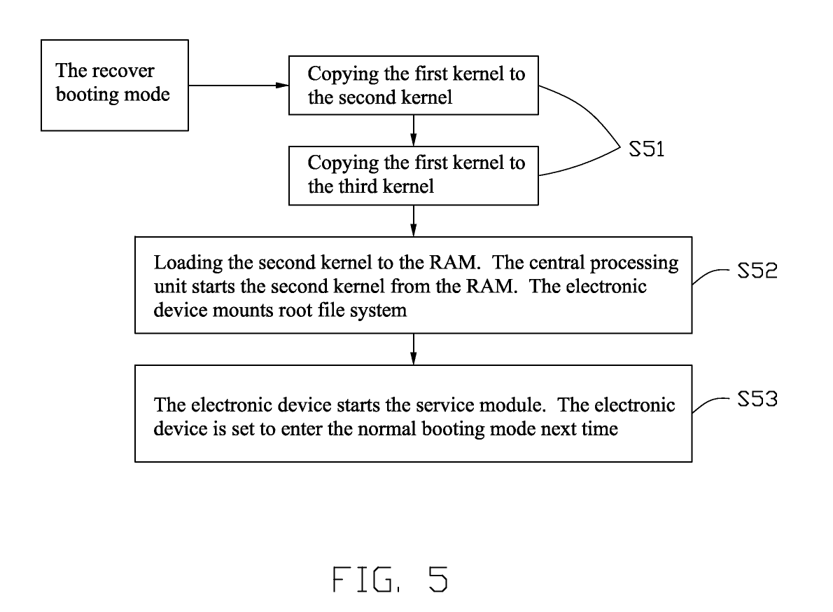

Referring to FIG. 5, one embodiment of a booting method for the electronic device 100 includes following blocks in the recover booting mode.

In block S51, the first kernel is copied to the second kernel and the third kernel. The first kernel is the original firmware.

In block S52, loading the second kernel to the RAM. The central processing unit starts the second kernel from the RAM. The electronic device 100 mounts root file system.

In block S53, the electronic device 100 starts the service module, such as system configuration service module. The electronic device 100 is set to enter the normal booting mode next time.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. An electronic device having a plurality of operating systems installed therein, the electronic device comprising:
a mode selecting module capable of selecting a desired booting mode from a plurality of booting modes, the booting modes comprising a manufacture booting mode, a normal booting mode, a rescue booting mode, and a recover booting mode;
a firmware module capable of storing the manufacture booting mode, the normal booting mode, the rescue booting mode, and the recover booting mode;
an operating system selecting module capable of selecting from one of a plurality of operating systems according to the selected booting mode; and
a boot loader module capable of loading the selected operating system.

2. The electronic device of claim 1, wherein the boot loader module is capable of loading the selected operating system onto a random access memory in the manufacture booting mode.

3. The electronic device of claim 2, wherein the selected operating system is capable of being started from the random access memory and the electronic device comprises a service module loaded to start up a service.

4. The electronic device of claim 2, wherein the boot loader module is capable of loading different operating systems according to a selected operating system kernel parameter value.

5. The electronic device of claim 1, wherein the electronic device comprises a rescue process module to rescue the firmware module in the rescue booting mode when the firmware module is wrong and the electronic device is set in the recover booting mode after rescuing successfully.

6. The electronic device of claim 1, wherein the boot loader module is capable of loading the selected operating system in the recover booting mode and causing the electronic device to be set to enter the normal booting mode next time.

7. The electronic device of claim 1, wherein during manufacturing the electronic device, the selected booting mode is a manufacture booting mode; during repairing the electronic device, the selected booting mode is a rescue booting mode; and during restoring the electronic device to factory settings, the selected booting mode is a recover booting mode.

8. The electronic device of claim 1, wherein a default booting mode is capable of being automatically selected as the desired booting mode if there is not any input command to change the default booting mode.

9. The electronic device of claim 8, wherein the default booting mode is the normal booting mode that is suitable for a common user of the electronic device.

10. The electronic device of claim 1, wherein the desired booting mode is capable of being selected according to a specific input command.

11. A booting method for an electronic device having multiple operating systems, comprising:
detecting a selection of a desired booting mode from a mode selecting module, the selected booting mode being a manufacture booting mode, a normal booting mode, a rescue booting mode, or a recover booting mode;
selecting a plurality of operating systems according to the selected booting mode via an operating system selecting module; and
loading the selected operating system by a boot loader module.

12. The booting method of claim 11, wherein the boot loader module loads the selected operating system to a random access memory in the manufacture booting mode.

13. The booting method of claim 12, wherein the selected operating system is started from the random access memory and a service module is loaded to start up a service.

14. The electronic device of claim 12, wherein the boot loader module loads different operating systems according to a selected operating system kernel parameter value.

15. The booting method of claim 11, wherein the electronic device comprises a rescue process module to rescue the firmware module in the rescue booting mode when the firmware module is wrong and the electronic device is set in the recover booting mode after rescuing successfully.

16. The booting method of claim 11, wherein the boot loader module loads the selected operating system in the recover booting mode and the electronic device is set to enter the normal booting mode next time.

17. The booting method of claim 11, wherein during manufacturing the electronic device, the selected booting mode is a manufacture booting mode; during repairing the electronic device, the selected booting mode is a rescue booting mode; and during restoring the electronic device to factory settings, the selected booting mode is a recover booting mode.

18. The booting method of claim 11, wherein a default booting mode is automatically selected as the desired booting mode unless the selection detected is different mode.

19. The booting method of claim 18, wherein the default booting mode is the normal booting mode that is suitable for a common user of the electronic device.

20. The booting method of claim 11, wherein the detection is done in accordance to a specific input command.
